(19) United States
(12) Patent Application Publication
(10) Pub. No.: US 2022/0269486 A1
(43) Pub. Date: Aug. 25, 2022

(54) FINAL EXPONENTIATION CALCULATION DEVICE, PAIRING OPERATION DEVICE, CRYPTOGRAPHIC PROCESSING DEVICE, FINAL EXPONENTIATION CALCULATION METHOD, AND COMPUTER READABLE MEDIUM

(71) Applicant: Mitsubishi Electric Corporation, Tokyo (JP)

(72) Inventors: Daiki HAYASHIDA, Tokyo (JP); Kenichiro HAYASAKA, Tokyo (JP)

(73) Assignee: Mitsubishi Electric Corporation, Tokyo (JP)

(21) Appl. No.: 17/735,190

(22) Filed: May 3, 2022

Related U.S. Application Data
(63) Continuation of application No. PCT/JP2019/051109, filed on Dec. 26, 2019.

(51) Int. Cl. G06F 7/556; G06F 17/11

(52) U.S. Cl. CPC G06F 7/556; G06F 17/11

(57) ABSTRACT

In a final exponentiation calculation device, a decomposition unit (221) decomposes an exponent part into an easy part and a hard part, using a cyclotomic polynomial, in a final exponentiation calculation part of a pairing operation on an elliptic curve represented by a polynomial r(u), a polynomial q(u), a polynomial t(u), an embedding degree k, and a parameter u. A transformation unit (222) transforms the hard part obtained by decomposition by the decomposition unit (221) into a linear sum of the polynomial q(u). An exponentiation calculation unit (23) calculates the final exponentiation calculation part, using the easy part and the hard part transformed into the linear sum of the polynomial q(u).

### CROSS REFERENCE TO RELATED APPLICATIONS

This application is a Continuation of PCT International Application No. PCT/JP2019/051109, filed on Dec. 26, 2019, which is hereby expressly incorporated by reference into the present application.

### TECHNICAL FIELD

The present disclosure relates to a technique to calculate a final exponentiation in a pairing operation.

### BACKGROUND ART

A pairing operation is an operation using an elliptic curve, which is processed internally in a cryptographic scheme such as functional encryption and searchable encryption. A Barret-Naehrig (BN) curve has been known as an elliptic curve with 128-bit level of security. In recent years, there has been an increasing demand for a pairing operation using an elliptic curve with 256-bit level of security, which is more secure.

The pairing operation is broadly divided into calculation of a Miller function and calculation of a final exponentiation. Both the calculation of the Miller function and the calculation of the final exponentiation require complicated calculation processes, significantly affecting the amount of calculation in the entire cryptographic scheme such as functional encryption and searchable encryption.

Non-Patent Literature 1 and Non-Patent Literature 2 discuss a Barreto-Lynn-Scott (BLS) curve, which is considered to be efficient for the entire pairing operation among many pairing-friendly curves. Non-Patent Literature 1 and Non-Patent Literature 2 discuss pairing operations on BLS curves with k=9, 15, 24, 27, 42, and 48, where k is an embedding degree. Patent Literature 1 and Non-Patent Literature 2 discuss a Kachisa-Schaefer-Scott (KSS) curve.

It is known that the amount of calculation in the final exponentiation is much heavier than the amount of calculation in the Miller function in the pairing operation on any of these curves.

A BLS curve is an elliptic curve determined by a polynomial r(u), a polynomial q(u), a polynomial t(u), an embedding degree k, and a parameter u. However, an elliptic curve with k=0 mod 18 is excluded. The polynomial r(u), the polynomial q(u), and the polynomial t(u) take different forms depending on the embedding degree k.

A BLS curve E with the embedding degree k is an elliptic curve defined over a finite filed F_{q} composed of q=q(u) elements. Note that r=r(u) is the maximum prime number that divides the order of a subgroup E(F_{q}) of the elliptic curve E, and t=t(u) is a trace of the elliptic curve E.

A pairing operation on the elliptic curve E is calculated by calculating a rational function f_{u,Q}(P) called a Miller function using as input certain two points P and Q on the elliptic curve E, and then performing an exponentiation to the power of (q(u)^{k}−1)/r(u).

That is, the pairing operation on the elliptic curve E is calculated by Formula 11.

$${{f}_{u , Q} ( P )}^{\frac{{q ( u )}^{k} - 1}{r ( u )}} \qquad [ Formula 11 ]$$

For the Miller function, a Miller algorithm, which can efficiently perform calculation for any curve, is known (refer to Non-Patent Literature 3). For the calculation of the final exponentiation, an efficient calculation method is known in which an exponent part is decomposed using a cyclotomic polynomial (refer to Non-Patent Literature 4). However, the final exponentiation involves a huge amount of calculation even when the method described in Non-Patent Literature 4 is used, and further speeding up is required for practical use.

The exponent part of the final exponentiation depends greatly on the polynomial parameters of the curve. For this reason, the method for decomposing the exponent part, that is, the method for speeding up is unique to each curve.

### CITATION LIST

### Patent Literature

Patent Literature 1: JP 2018-205511 A

### Non-Patent Literature

Non-Patent Literature 1: X. Zhang, D. Lin, “Analysis of Optimum Pairing Products at High Security Levels”, INDOCRYPT 2012, p. 412-430
Non-Patent Literature 2: Y. Kiyomura, A. Inoue, Y. Kawahara, M. Yasuda, T. Takagi, T. Kobayashi, “Secure and Efficient Pairing at 256-Bit Security Lebel”, ACNS2017, p. 59-79
Non-Patent Literature 3: Victor S. Miller, “The Weil pairing, and its efficient calculation”, J. Cryptology, 17(4), 2004, p. 235-261
Non-Patent Literature 4: M. Scott, N. Benger, M. Charlemagne, “On the Final Exponentiation for Calculating Pairings on Ordinary Elliptic Curves”. Pairing 2009, p. 78-88

### SUMMARY OF INVENTION

### Technical Problem

With BLS curves with embedding degrees other than embedding degrees that have been previously studied, the calculation in the Miller function requires more time in comparison with other elliptic curves such as a KSS type, or there is no known method for speeding up the calculation of the final exponentiation.

An object of the present disclosure is to make it possible to efficiently calculate a final exponentiation in a pairing operation.

### Solution to Problem

A final exponentiation calculation device according to the present disclosure includes a decomposition unit to decompose an exponent part into an easy part and a

hard part, using a cyclotomic polynomial, the exponent part being in a final exponentiation calculation part of a pairing operation on an elliptic curve represented by a polynomial r(u), a polynomial q(u), a polynomial t(u), an embedding degree k, and a parameter u; and

a transformation unit to transform the hard part obtained as a result of decomposition by the decomposition unit into a linear sum of the polynomial q(u).

### Advantageous Effects of Invention

In the present disclosure, an exponent part is decomposed into an easy part and a hard part, using a cyclotomic polynomial, and the hard part is transformed into a linear sum of a polynomial q(u). This makes it possible to efficiently calculate a final exponentiation in a pairing operation.

### BRIEF DESCRIPTION OF DRAWINGS

FIG. 1 is a configuration diagram of a pairing operation device 10 according to a first embodiment;

FIG. 2 is a flowchart of an overall process of the pairing operation device 10 according to the first embodiment;

FIG. 3 is a diagram describing an exponentiation simplification process according to the first embodiment:

FIG. 4 is a flowchart of a Miller function calculation process according to the first embodiment;

FIG. 5 is a flowchart of the exponentiation simplification process according to the first embodiment:

FIG. 6 is a flowchart of an exponentiation calculation process according to the first embodiment:

FIG. 7 is a flowchart of a process to generate a first factor A₁(u) according to the first embodiment;

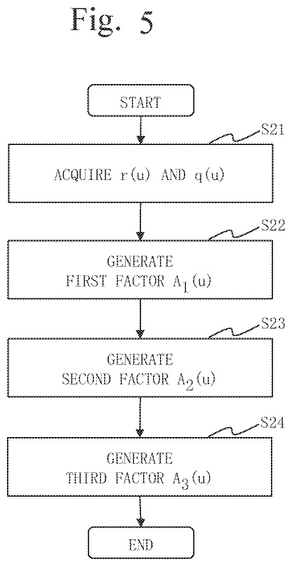

FIG. 5 is a flowchart of a process to generate a second factor A₂(u) according to the first embodiment;

FIG. 9 is a flowchart of a process to generate a third factor A₃(u) according to the first embodiment:

FIG. 10 is a diagram describing a conventional method of calculating an exponent part in a final exponentiation calculation part;

FIG. 11 is a diagram describing a method of calculating an exponent part in a final exponentiation calculation part according to the first embodiment:

FIG. 12 is a configuration diagram of the pairing operation device 10 according to a first variation;

FIG. 13 is a configuration diagram of a Miller function calculation device 10A according to a third variation;

FIG. 14 is a configuration diagram of a final exponentiation simplification device 10B according to the third variation;

FIG. 15 is a configuration diagram of a final exponentiation calculation device 10C according to the third variation:

FIG. 16 is a configuration diagram of a cryptographic processing device 30 according to a second embodiment; and

FIG. 17 is a flowchart of an overall process of the cryptographic processing device 30 according to the second embodiment.

### DESCRIPTION OF EMBODIMENTS

### First Embodiment

*** Description of Notation *** In the text of the description and in the drawings, an exponentiation may be denoted using “\hat{ }”. A specific example is that a\hat{ }b denotes a^{b}.

***Description of Configuration ***

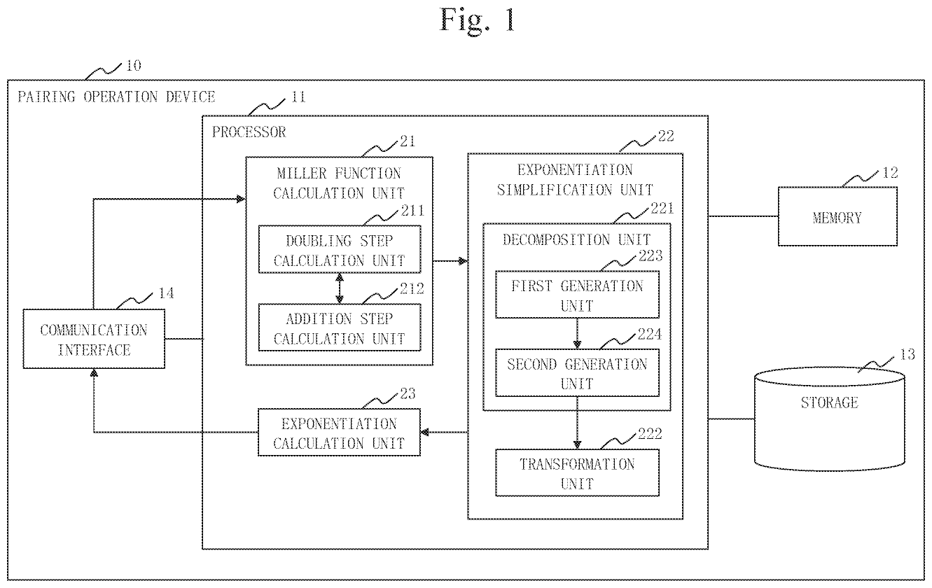

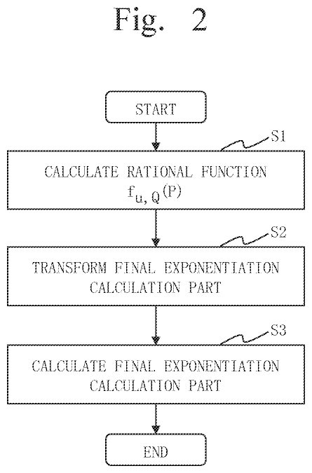

Referring to FIG. 1, a configuration of a pairing operation device 10 according to a first embodiment will be described.

The pairing operation device 10 is a computer.

The pairing operation device 10 includes hardware of a processor 11, a memory 12, a storage 13, and a communication interface 14. The processor 11 is connected with other hardware components through signal lines, and controls these other hardware components.

The processor 11 is an integrated circuit (IC) that performs processing. Specific examples of the processor 11 are a central processing unit (CPU), a digital signal processor (DSP), and a graphics processing unit (GPU).

The memory 12 is a storage device to temporarily store data. Specific examples of the memory 12 are a static random access memory (SRAM) and a dynamic random access memory (DRAM).

The storage 13 is a storage device to store data. A specific example of the storage 13 is a hard disk drive (HDD). Alternatively, the storage 13 may be a portable recording medium such as a Secure Digital (SD, registered trademark) memory card, CompactFlash (CF, registered trademark), a NAND flash, a flexible disk, an optical disc, a compact disc, a Blu-ray (registered trademark) disc, and a digital versatile disc (DVD).

The communication interface 14 is an interface for communicating with external devices. Specific examples of the communication interface 14 are an Ethernet (registered trademark) port, a Universal Serial Bus (USB) port, and a High-Definition Multimedia Interface (HDMI, registered trademark) port.

The pairing operation device 10 includes, as functional components, a Miller function calculation unit 21, an exponentiation simplification unit 22, and an exponentiation calculation unit 23. The Miller function calculation unit 21 includes a doubling step calculation unit 211 and an addition step calculation unit 212. The exponentiation simplification unit 22 includes a decomposition unit 221 and a transformation unit 222. The decomposition unit 221 includes a first generation unit 223 and a second generation unit 224. The functions of the functional components of the pairing operation device 10 are realized by software.

The storage 13 stores programs that realize the functions of the functional components of the pairing operation device 10. These programs are loaded into the memory 12 by the processor 11 and executed by the processor 11. This realizes the functions of the functional components of the pairing operation device 10.

In FIG. 1, only one processor 11 is illustrated. However, a plurality of processors 11 may be included, and the plurality of processors 11 may cooperatively execute the programs that realize the functions.

*** Description of Operation ***

Referring to FIGS. 2 to 9, operation of the pairing operation device 10 according to the first embodiment will be described.

A procedure for the operation of the pairing operation device 10 according to the first embodiment is equivalent to a pairing operation method according to the first embodiment. A program that realizes the operation of the pairing operation device 10 according to the first embodiment is equivalent to a pairing operation program according to the first embodiment.

In the first embodiment, the pairing operation device 10 uses a BLS21 curve. The BLS21 curve is a BLS curve with an embedding degree that is not considered in Non-Patent Literature 1 and Non-Patent Literature 2.

A BLS curve is an elliptic curve determined by a polynomial r(u), a polynomial q(u), a polynomial t(u), an embedding degree k, and a parameter u. However, an elliptic curve with k=0 mod 18 is excluded. The polynomial r(u), the polynomial q(u), and the polynomial t(u) take different forms depending on the embedding degree k. The BLS21 curve is the BLS curve with the embedding degree k of 21.

A BLS curve E with the embedding degree k is an elliptic curve defined over a finite field F_{q} composed of q=q(u) elements. Note that r=r(u) is the maximum prime number that divides the order of a subgroup E(F_{q}) of the elliptic curve E, and t=t(u) is a trace of the elliptic curve E.

The polynomial r(u), the polynomial q(u), and the polynomial t(u) are polynomial parameters that are determined depending on the embedding degree k.

The parameter u is the parameter that can be determined independently of the embedding degree k.

In the first embodiment, the parameter u is 2⁴³+2³⁹+2³⁷+2⁶=9483287789632.

This parameter u is a value selected based on the following conditions (1) to (3). Condition (1): Both the polynomial r(u) and the polynomial q(u) are prime numbers. Condition (2): The polynomial r(u) is a prime number of about 512 bits. Condition (3): The Hamming weight is small.

The condition (1) is the condition for constructing an elliptic curve. The condition (2) is the condition for satisfying 256 bits of security. The condition (3) is the condition for speeding up a pairing operation.

The above parameter u satisfies the conditions (1) and (2) and the Hamming weight is 4. Since the Hamming weight is very small, a pairing operation can be speeded up.

A pairing operation on the elliptic curve E, which is the BLS21 curve, is calculated by calculating a rational function f_{u,Q}(P) called a Miller function using as input certain two points P and Q on the elliptic curve E, and then performing an exponentiation to the power of (q(u)²¹−1)/r(u).

Referring to FIG. 2, an overall process of the pairing operation device 10 according to the first embodiment will be described.

(Step S1: Miller Function Calculation Process)

The Miller function calculation unit 21 calculates the rational function f_{u,Q}(P) by a Miller algorithm, using as input two points P and Q on the elliptic curve E, which is the BLS21 curve.

(Step S2: Exponentiation Simplification Process)

The decomposition unit 221 of the exponentiation simplification unit 22 decomposes an exponent part in a final exponentiation calculation part into an easy part and a hard part, using a cyclotomic polynomial Φ₂₁. Furthermore, the transformation unit 222 of the exponentiation simplification unit 22 transforms the hard part obtained by decomposition by the decomposition unit 221 into a linear sum of the polynomial q(u).

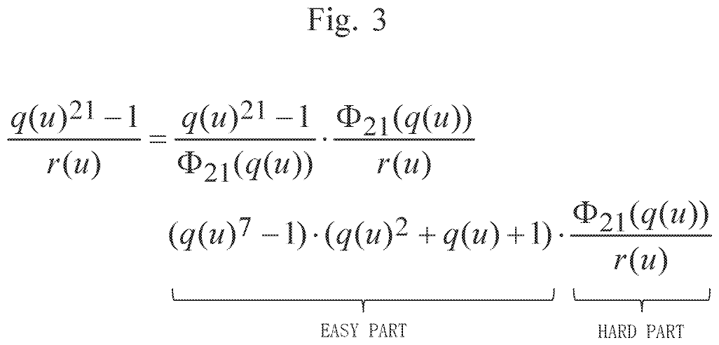

Specifically, as indicated in FIG. 3, the decomposition unit 221 decomposes (q(u)²¹−1)/r(u), which is the exponent part in the final exponentiation calculation part, into the easy part indicated in Formula 12 and the hard part indicated in Formula 13. The easy part is the part expressed by exponentiations of q(u). The hard part is the part expressed by exponentiations of u. The transformation unit 222 transforms the hard part into the linear sum of q(u) with a degree of 11, as indicated in Formula 14. Note that λᵢ(u) in Formula 14 will be described later.

However, if the hard part is simply transformed, ⅓ appears as a coefficient. That is, a cube root needs to be calculated. The amount of calculation to calculate a cube root is heavy. For this reason, the transformation unit 222 removes ⅓ that appears as the coefficient.

$$\begin{matrix}( {q ( u )}^{7} - 1 ) \cdot ( {q ( u )}^{2} + q ( u ) + 1 ) & [ Formula 12 ] \\ \frac{{Φ}_{21} ( q ( u ) )}{r ( u )} & [ Formula 13 ] \\ {\sum }_{i = 0}^{11} {λ}_{i} ( u ) {q ( u )}^{i} & [ Formula 14 ]\end{matrix}$$

(Step S3: Exponentiation Calculation Process)

For the rational function f_{u,Q}(P) calculated in step S1, the exponentiation calculation unit 23 calculates exponentiations of the easy part obtained in step S2 and exponentiations of the hard part transformed into the linear sum by the transformation unit 222 in step S2. As a result, the pairing operation indicated in Formula 16 is calculated, in which the pairing operation indicated in Formula 15 is further raised to the power of 3.

The reason for calculating the result of raising the pairing operation to the power of 3 is that ⅓ that appears as the coefficient is removed in step S2.

$$\begin{matrix}{f}_{u , Q} {( P )}^{\frac{{q ( u )}^{21} - 1}{r ( u )}} & [ Formula 15 ] \\ {f}_{u , Q} {( P )}^{3 \cdot \frac{{q ( u )}^{21} - 1}{r ( u )}} & [ Formula 16 ]\end{matrix}$$

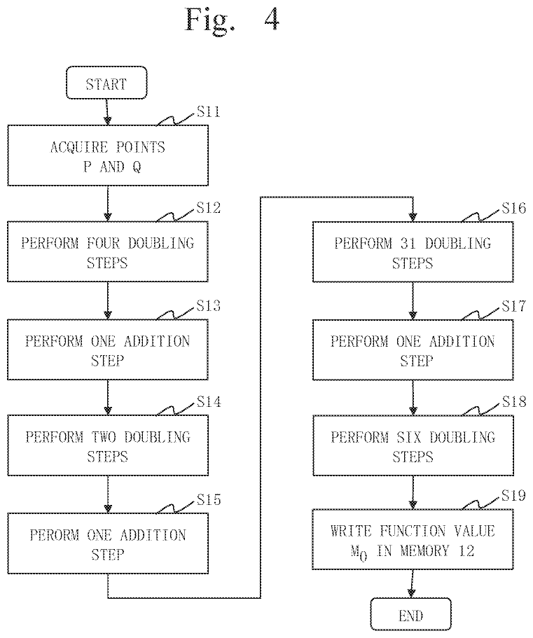

Referring to FIG. 4, a Miller function calculation process according to the first embodiment will be described.

In step S11, the Miller function calculation unit 21 acquires two points P and Q on the elliptic curve E, which is the BLS21 curve.

In step S12, the doubling step calculation unit 211 repeatedly performs four doubling steps. In step S13, the addition step calculation unit 212 performs one addition step. In step S14, the doubling step calculation unit 211 repeatedly performs two doubling steps. In step S15, the addition step calculation unit 212 performs one addition step. In step S16, the doubling step calculation unit 211 repeatedly performs 31 doubling steps. In step S17, the addition step calculation unit 212 performs one addition step. In step S18, the doubling step calculation unit 211 repeatedly performs six doubling steps. As a result, the Miller function of the pairing operation is calculated.

In step S19, the Miller function calculation unit 21 writes a function value M₀, which is the result of calculation in step S18, in the memory 12.

In the first embodiment, the parameter u is 2⁴³+2³⁹+2³⁷+2⁶. Therefore, the Miller function calculation unit 21 can calculate the Miller function as indicated in FIG. 4.

Referring to FIG. 5, an exponentiation simplification process according to the first embodiment will be described.

In step S21, the exponentiation simplification unit 22 acquires the polynomial r(u) and the polynomial q(u), which are the polynomial parameters of the elliptic curve E, which is the BLS21 curve.

In step S22, the first generation unit 223 of the decomposition unit 221 generates a first factor A₁(u) of (q(u)²¹−1)/r(u). The first factor A₁(u) is a portion of the easy part, as indicated in Formula 17. The first generation unit 223 writes the first factor A₁(u) in the memory 12.

$$( {q ( u )}^{7} - 1 ) \qquad [ Formula 17 ]$$

In step S23, the second generation unit 224 of the decomposition unit 221 generates a second factor A₂(u) of (q(u)²¹−1)/r(u). The second factor A₂(u) is the remaining portion of the easy part, as indicated in Formula 18. The second generation unit 224 writes the second factor A₂(u) in the memory 12.

$$( {q ( u )}^{2} + q ( u ) + 1 ) \qquad [ Formula 18 ]$$

In step S24, the transformation unit 222 generates a third factor A₃(u) of (q(u)¹¹−1)/r(u). The third factor A₃(u) is the factor obtained by transforming the hard part into the linear sum with a degree of 11 and removing ⅓ that appears as the coefficient, as indicated in Formula 19. The transformation unit 222 writes the third factor A₃(u) in the memory 12.

$${\sum }_{i = 0}^{11} {λ}_{i} ( u ) {q ( u )}^{i} \qquad [ Formula 19 ]$$

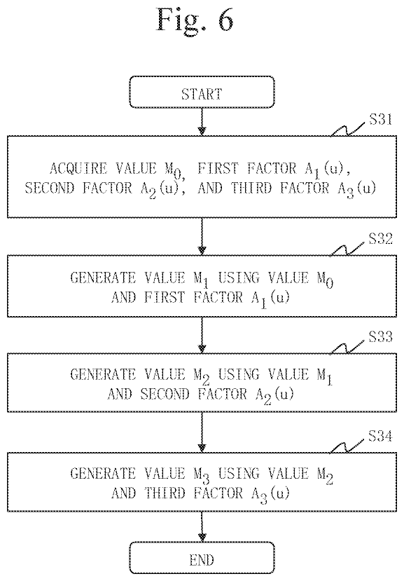

Referring to FIG. 6, an exponentiation calculation process according to the first embodiment will be described.

In step S31, the exponentiation calculation unit 23 reads out from the memory 12 the function value M₀ calculated in the Miller function calculation process and also the first factor A₁(u), the second factor A₂(u), and the third factor A₃(u) generated in the exponentiation simplification process.

In step S32, the exponentiation calculation unit 23 calculates an exponentiation in which the base is the function value M₀ and the exponent is the first factor A₁(u) so as to generate a value M₁. That is, the exponentiation calculation unit 23 calculates the value M₁ by Formula 20.

$${M}_{1} = {{f}_{u , Q} ( P )}^{{A}_{1} ( u )} \qquad [ Formula 20 ]$$

In step S33, the exponentiation calculation unit 23 calculates an exponentiation in which the base is the value M₁ and the exponent is the second factor A₂(u) so as to generate a value M₂. That is, the exponentiation calculation unit 23 calculates the value M₂ by Formula 21.

$${M}_{2} = {M}_{1}^{{A}_{2} ( u )} \qquad [ Formula 21 ]$$

In step S34, the exponentiation calculation unit 23 calculates an exponentiation in which the base is the value M₂ and the exponent is the third factor A₃(u) so as to generate a value M₃. That is, the exponentiation calculation unit 23 calculates the value M₃ by Formula 22.

$${M}_{3} = {M}_{2}^{{A}_{3} ( u )} \qquad [ Formula 22 ]$$

The value M₃ is the result of the pairing operation indicated in Formula 16.

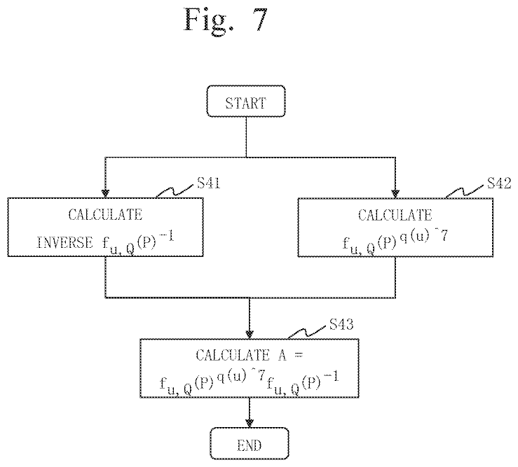

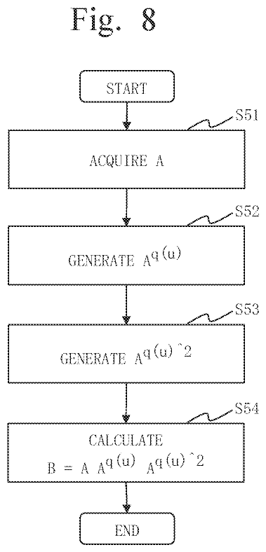

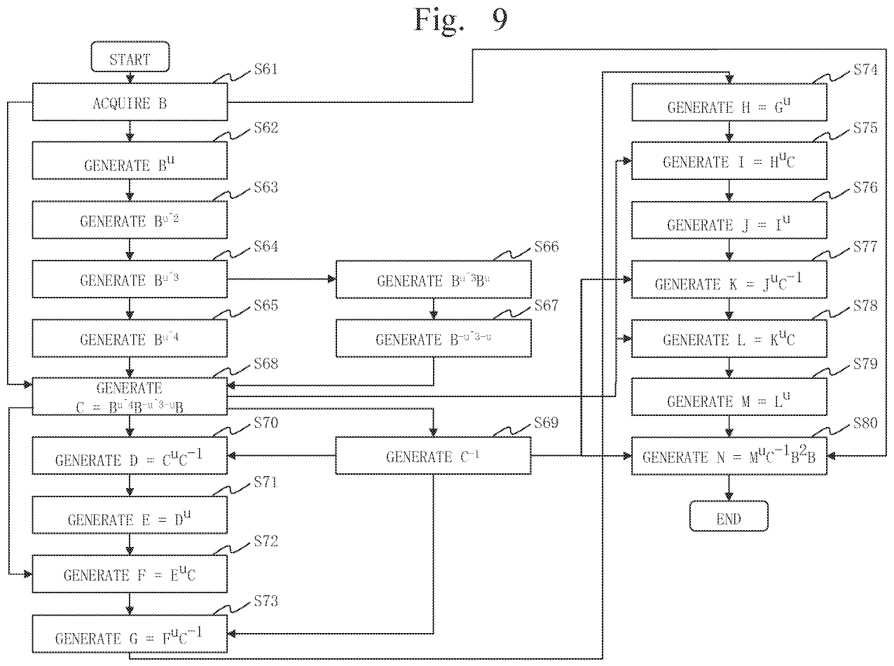

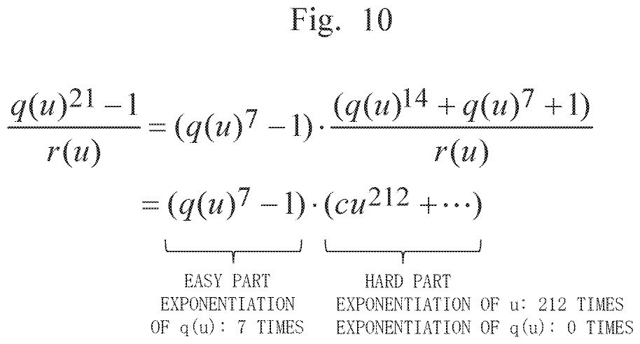

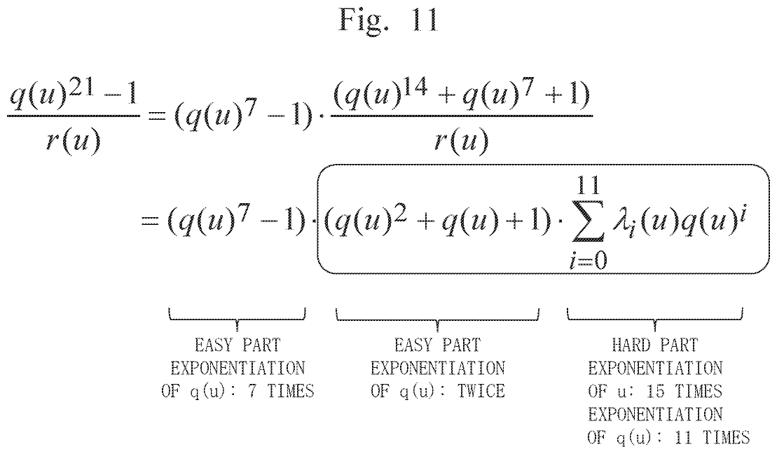

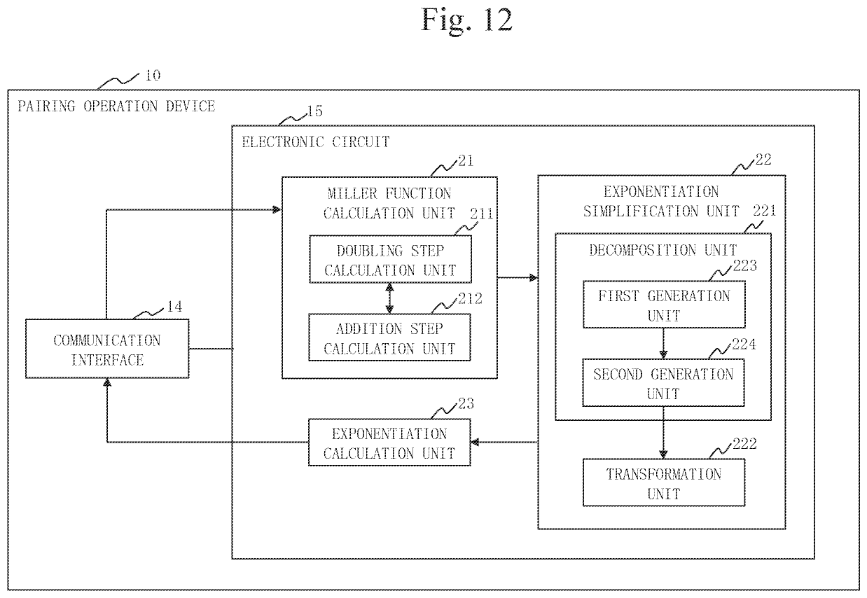

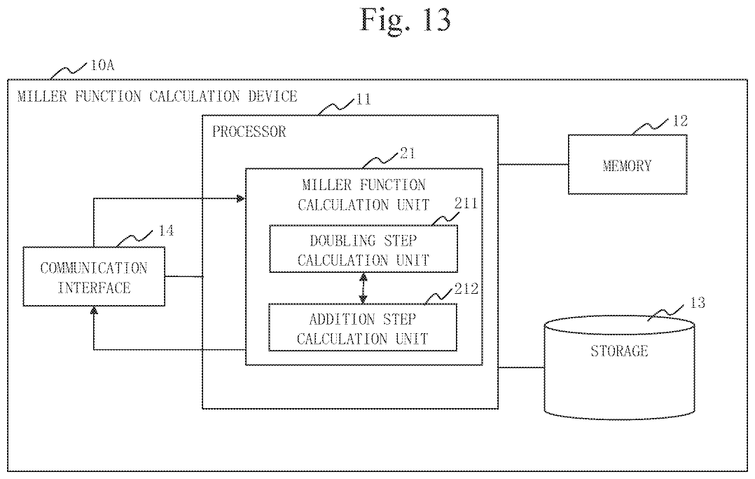

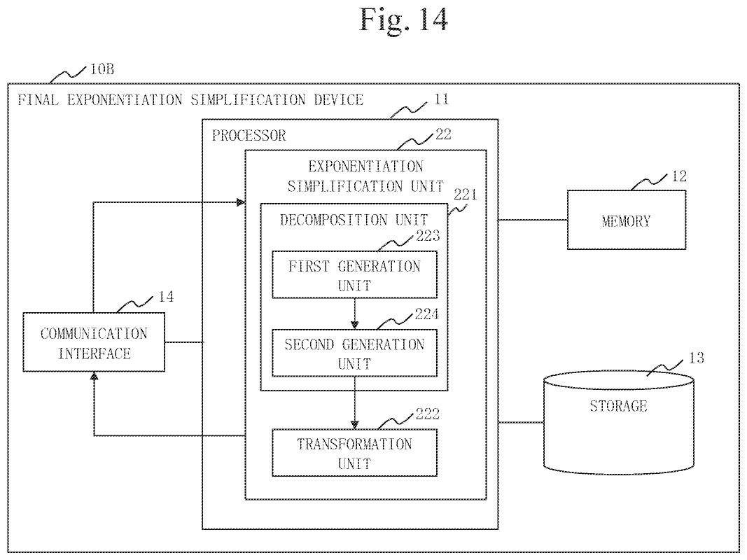

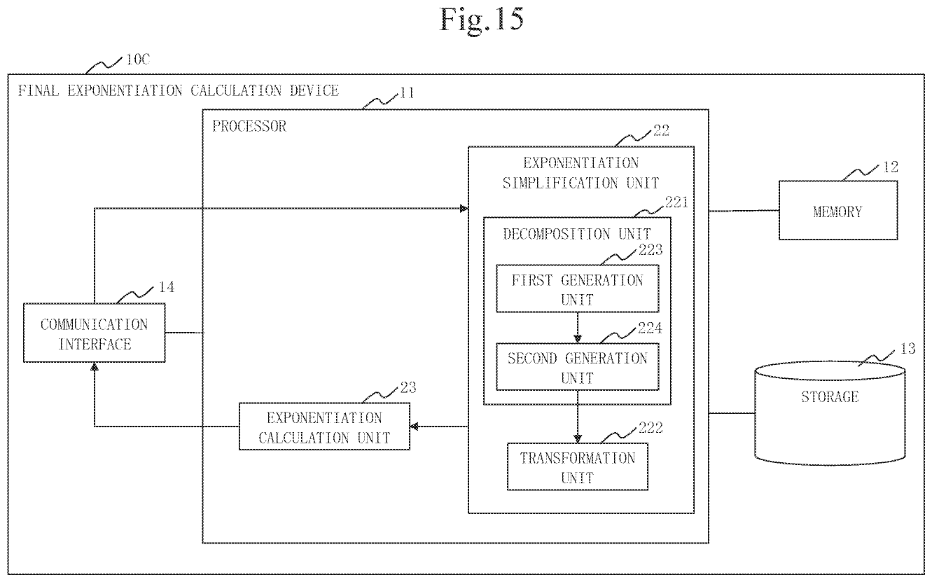

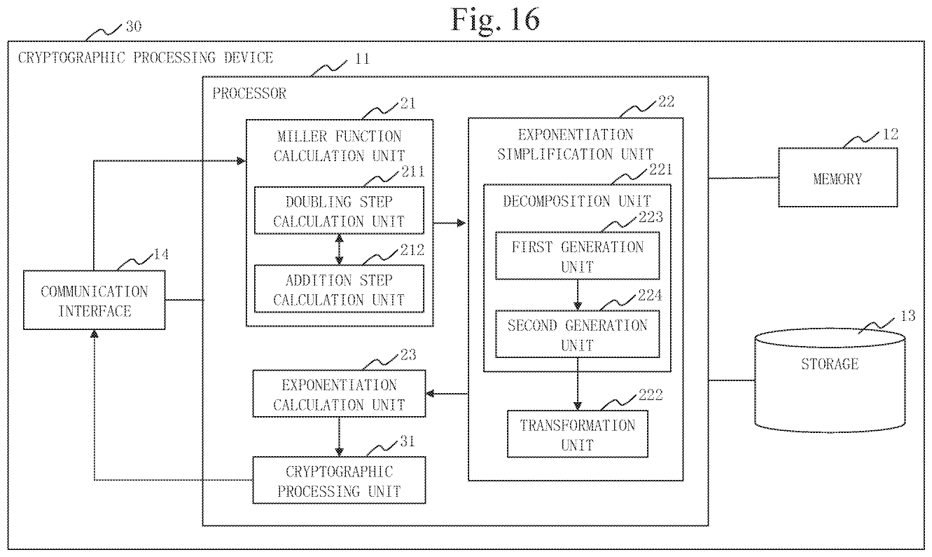

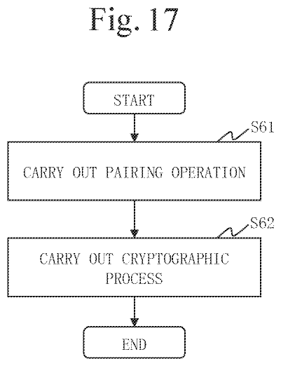

Referring to FIG. 7, a process to generate the first factor A₁(u) according to the first embodiment will be described.

In step S41, the first generation unit 223 calculates an inverse f_{u,Q}(P)⁻¹ of the rational function f_{u,Q}(P). In step S42, the first generation unit 223 calculates an element indicated in Formula 23. In step S43, the first generation unit 223 calculates an element A indicated in Formula 24, using the inverse f_{u,Q}(P)⁻¹ calculated in step S41 and the element indicated in Formula 23.

$$\begin{matrix}{{f}_{u , Q} ( P )}^{{q ( u )}^{7}} & [ Formula 23 ] \\ A = {{f}_{u , Q} ( P )}^{{q ( u )}^{7}} \cdot {{f}_{u , Q} ( P )}^{- 1} & [ Formula 24 ]\end{matrix}$$

The element A is as indicated in Formula 25. Therefore, q(u)⁷−1 of the exponent part is obtained as the first factor A₁(u).

$$A = {{f}_{u , Q} ( P )}^{{q ( u )}^{7} - 1} \qquad [ Formula 25 ]$$

Referring to FIG. 8, a process to generate the second factor A₂(u) according to the first embodiment will be described.

In step S51, the second generation unit 224 acquires the element A generated in the process to generate the first factor A₁(u). In step S52, the second generation unit 224 calculates an element indicated in Formula 26. In step S53, the second generation unit 224 calculates an element indicated in Formula 27. In step S54, an element B indicated in Formula 28 is calculated using the element A, the element indicated in Formula 26, and the element indicated in Formula 27.

$$\begin{matrix}{A}^{q ( u )} & [ Formula 26 ] \\ {A}^{{q ( u )}^{2}} & [ Formula 27 ] \\ B = A \cdot {A}^{q ( u )} \cdot {A}^{{q ( u )}^{2}} & [ Formula 28 ]\end{matrix}$$

The element B is as indicated in Formula 29. Therefore, q(u)²+q(u)+1 in the exponent part is obtained as the second factor A₂(u).

$$B = {A}^{{q ( u )}^{2} + q ( u ) + 1} \qquad [ Formula 29 ]$$

Referring to FIG. 9, a process to generate the third factor A₃(u) according to the first embodiment will be described.

The process to generate the third factor A₃(u) is the process of extracting terms of q(u) from the hard part and transforming the hard part into the linear sum with a degree of 11, as indicated in Formula 30. The hard part is transformed into the linear sum of q(u) with a degree of 11 by identifying L(u) in descending order of i=0, . . . , 11 in Formula 30.

In step S61, the transformation unit 222 acquires the element B generated in the process to generate the second factor A₂(u).

In step S62, the transformation unit 222 generates B^{u}, using the element B. In step S63, the transformation unit 222 generates an element indicated in Formula 31, using B^{u} generated in step S62. In step S64, the transformation unit 222 generates an element indicated in Formula 32, using the element indicated in Formula 31 generated in step S63. In step S65, the transformation unit 222 generates an element indicated in Formula 33, using the element indicated in Formula 32 generated in step S64.

$$\begin{matrix}\frac{{Φ}_{21} ( q ( u ) )}{r ( u )} = {\sum }_{i = 0}^{11} {λ}_{i} ( u ) {q ( u )}^{i} & [ Formula 30 ] \\ {Bu}^{2} & [ Formula 31 ] \\ {Bu}^{3} & [ Formula 32 ] \\ {Bu}^{4} & [ Formula 33 ]\end{matrix}$$

In step S66, the transformation unit 222 generates an element indicated in Formula 34, using B^{u} generated in step S62 and the element indicated in Formula 32 generated in step S64. In step S67, the transformation unit 222 generates an inverse, indicated in Formula 35, of the element indicated in Formula 34 generated in step S66.

$$\begin{matrix}{B}^{{u}^{3}} \cdot {B}^{u} & [ Formula 34 ] \\ {B}^{- {u}^{3} - u} & [ Formula 35 ]\end{matrix}$$

In step S68, the transformation unit 222 generates an element C indicated in Formula 36, using the element B, the element indicated in Formula 33 generated in step S65, and the element indicated in Formula 35 generated in step S67.

$$C = {B}^{{u}^{4}} \cdot {B}^{- {u}^{3} - u} \cdot B \qquad [ Formula 36 ]$$

The exponent part, u⁴−u³−u+1, of the element C corresponds to λ₁₁(u) in Formula 30.

In step S69, the transformation unit 222 generates an inverse C⁻¹ of the element C generated in step S68. In step S70, the transformation unit 222 generates an element D=C^{u}·C⁻¹, using the element C generated in step S68 and the inverse C⁻¹ generated in step S69.

The exponent part, (u−1)λ₁₁(u), of the element B in the element D corresponds to λ₁₀(u) in Formula 30.

In step S71, the transformation unit 222 generates an element E=D^{u}, using the element D generated in step S70. The exponent part, uλ₁₀(u), of the element B in the element E corresponds to λ₉(u) in Formula 30.

In step S72, the transformation unit 222 generates an element F=E^{u}·C, using the element C generated in step S68 and the element E generated in step S71. The exponent part, uλ₉(u)+λ₁₁(u), of the element B in the element F corresponds to λ₈(u) in Formula 30.

In step S73, the transformation unit 222 generates an element G=F^{u}·C⁻¹, using the inverse C⁻¹ generated in step S69 and the element F generated in step S72. The exponent part, uλ₈(u)−λ₁₁(u), of the element B in the element G corresponds to λ₇(u) in Formula 30.

In step S74, the transformation unit 222 generates an element H=G^{u}, using the element G generated in step S73. The exponent part, uλ₇(u), of the element B in the element H corresponds to (u) in Formula 30.

In step S75, the transformation unit 222 generates an element I=H^{u}·C, using the element C generated in step S68 and the element H generated in step S74. The exponent part, uλ₆(u)+λ₁₁(u), of the element B in the element I corresponds to λ₅(u) in Formula 30.

In step S76, the transformation unit 222 generates an element J=I^{u}, using the element I generated in step S75. The exponent part, uλ₅(u), of the element B in the element J corresponds to λ₄(u) in Formula 30.

In step S77, the transformation unit 222 generates an element K=J^{u}·C⁻¹, using the element C generated in step S68 and the element J generated in step S76. The exponent part, uλ₄(u)−λ₁₁(u), of the element B in the element K corresponds to λ₃(u) in Formula 30.

In step S78, the transformation unit 222 generates an element L=J^{u}·C, using the element C generated in step S68 and the element K generated in step S77. The exponent part, uλ₃(u)+λ₁₁(u), of the element B in the element L corresponds to λ₂(u) in Formula 30.

In step S79, the transformation unit 222 generates an element M=L^{u}, using the element L generated in step S78. The exponent part, uλ₂(u), of the element B in the element M corresponds to λ₁(u) in Formula 30.

In step S80, the transformation unit 222 generates an element N=M^{u}·C⁻¹·B²·B, using the element B, the element C generated in step S68, and the element M generated in step S79. The exponent part, uλ₁(u)−λ₁₁(u)+3, of the element B in the element N corresponds to λ₀(u) in Formula 30.

As a result of the above, the third factor A₃(u) indicated in Formula 37 is obtained.

$$\begin{matrix}{A}_{3} ( u ) = {\sum }_{i = 0}^{11} {λ}_{i} ( u ) {q ( u )}^{i} & [ Formula 37 ] \\ where & \\ {λ}_{11} ( u ) = {u}^{4} - {u}^{3} - u + 1 , & \\ {λ}_{10} ( u ) = ( u - 1 ) {λ}_{11} ( u ) , & \\ {λ}_{9} ( u ) = u {λ}_{10} ( u ) , & \\ {λ}_{8} ( u ) = u {λ}_{9} ( u ) + {λ}_{11} ( u ) , & \\ {λ}_{7} ( u ) = u {λ}_{8} ( u ) - {λ}_{11} ( u ) , & \\ {λ}_{6} ( u ) = u {λ}_{7} ( u ) , & \\ {λ}_{5} ( u ) = u {λ}_{6} ( u ) + {λ}_{11} ( u ) , & \\ {λ}_{4} ( u ) = u {λ}_{5} ( u ) , & \\ {λ}_{3} ( u ) = u {λ}_{4} ( u ) - {λ}_{11} ( u ) , & \\ {λ}_{2} ( u ) = u {λ}_{3} ( u ) + {λ}_{11} ( u ) , & \\ {λ}_{1} ( u ) = u {λ}_{2} ( u ) , & \\ {λ}_{0} ( u ) = u {λ}_{1} ( u ) - {λ}_{11} ( u ) + 3. & \end{matrix}$$

### Effects of First Embodiment

As described above, the pairing operation device 10 according to the first embodiment decomposes the exponent part into the easy part and the hard part, using the cyclotomic polynomial Φ₂₁, and transforms the hard part into the linear sum of the polynomial q(u). This makes it possible to efficiently calculate a pairing operation.

Specifically, by transforming the hard part into the linear sum of the polynomial q(u) with a degree of 11, the number of exponentiations of u is significantly reduced at the cost of a slight increase in the number of exponentiations of q(u). It is known that the amount of calculation for an exponentiation of u is much heavier than the amount of calculation for an exponentiation of q(u). Therefore, by transforming the hard part into the linear sum with a degree of 11, the pairing operation device 10 according to the first embodiment can efficiently calculate a pairing operation.

More specifically, in a conventional method of decomposing the exponent part using the cyclotomic polynomial Φ₂₁, (q(u)²¹−1)/r(u), which is the exponent part in the final exponentiation calculation part, is decomposed as indicated in FIG. 10. In this case, the easy part expressed by exponentiations of q(u) includes seven exponentiations of q(u). The part part expressed by exponentiations of u includes 212 exponentiations of u and zero exponentiations of q(u).

In contrast to this, the pairing operation device 10 according to the first embodiment further decomposes the conventional hard part into the easy part expressed by exponentiations of q(u) and the hard part expressed by exponentiations of u, as indicated in FIG. 11. Then, the hard part is transformed into the linear sum of q(u) with a degree of 11. This transforms the conventional hard part including 212 exponentiations of u and zero exponentiations of q(u) into the easy part including two exponentiations of q(u) and the hard part including 15 exponentiations of u and 11 exponentiations of q(u). The breakdown of the number of exponentiations of u in the hard part of the first embodiment is once for each of λ₀(u) to λ₁₀(u) and four times for λ₁₁(u), resulting in a total of 15 times.

Note that the amount of calculation for an exponentiation of u is about 200 times the amount of calculation for an exponentiation of q(u). Accordingly, let I be the cost of one exponentiation of q(u), and let 200 be the cost of one exponentiation of u. Then, the cost of the conventional final exponentiation calculation part is 1×7+200×212=42407. In contrast to this, the cost of the final exponentiation calculation part of the first embodiment is 1×7+1×2+200×15+1×11=3020.

The pairing operation device 10 according to the first embodiment calculates a result of raising a pairing operation to the power of 3 instead of calculating a cube root in the final exponentiation calculation part. By eliminating the calculation of a cube root, the amount of calculation in the final exponentiation calculation part can be reduced.

If a pairing operation is used on the assumption that a result raised to the power of 3 is obtained, it can be used in the same way as a typical pairing operation.

The pairing operation device 10 according to the first embodiment uses the BLS21 curve as the elliptic curve E. There is no known method for speeding up a pairing operation using the BLS21 curve. By using the BLS21 curve as the elliptic curve E and transforming the hard part into the linear sum with a degree of 11, the pairing operation device 10 according to the first embodiment can efficiently calculate a pairing operation in comparison with cases in which other curves are used.

The pairing operation device 10 according to the first embodiment uses 2⁴³+2³⁹+2³⁷+2⁶ as the parameter u. Therefore, the pairing operation device 10 can calculate the Miller function as indicated in FIG. 4. This allows the Miller function to be efficiently calculated. As a result, a pairing operation can be efficiently calculated.

That is, the parameter u that satisfies the conditions (1) and (2) and also has a small Hamming weight, as specified in the condition (3), is used. This allows the amount of calculation in the Miller function to be reduced.

*** Other Configurations ***

<First Variation>

In the first embodiment, the functional components are realized by software. As a first variation, however, the functional components may be realized by hardware. With regard to this first variation, differences from the first embodiment will be described.

Referring to FIG. 12, a configuration of the pairing operation device 10 according to the first variation will be described.

When the functional components are realized by hardware, the pairing operation device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, a parallel-programmed processor, a logic IC, a gate array (GA), an application specific integrated circuit (ASCI), or a field-programmable gate array (FPGA).

The functional components may be realized by one electronic circuit 15, or may be distributed among and realized by a plurality of electronic circuits 15.

<Second Variation>

As a second variation, some of the functional components may be realized by hardware, and the rest of the functional components may be realized by software.

Each of the processor 11, the memory 12, the storage 13, and the electronic circuit 15 is referred to as processing circuitry. That is, the functions of the functional components are realized by the processing circuitry.

<Third Variation>

One or more functional components of the functional components of the pairing operation device 10 may be implemented as a separate device. For example, as illustrated in FIG. 13, the Miller function calculation unit 21 may be implemented as a Miller function calculation device 10A. As illustrated in FIG. 14, the exponentiation simplification unit 22 may be implemented as a final exponentiation simplification device 10B. As illustrated in FIG. 15, the exponentiation simplification unit 22 and the exponentiation calculation unit 23 may be implemented as a final exponentiation calculation device 10C.

### Second Embodiment

In the first embodiment, the method for a pairing operation has been described. In a second embodiment, a process using a result of a pairing operation calculated in the first embodiment will be described. In the second embodiment, differences from the first embodiment will be described, and description of the same aspects will be omitted.

*** Description of Configuration ***

Referring to FIG. 16, a configuration of a cryptographic processing device 30 according to the second embodiment will be described.

The cryptographic processing device 30 includes a cryptographic processing unit 31 in addition to the functional components included in the pairing operation device 10 according to the first embodiment. Like the functional components included in the pairing operation device 10, the cryptographic processing unit 31 is realized by software or hardware.

*** Description of Operation ***

Referring to FIG. 17, operation of the cryptographic processing device 30 according to the second embodiment will be described.

A procedure for the operation of the cryptographic processing device 30 according to the second embodiment is equivalent to a cryptographic processing method according to the second embodiment. A program that realizes the operation of the cryptographic processing device 30 according to the second embodiment is equivalent to a cryptographic processing program according to the second embodiment.

(Step S61: Pairing Operation Process)

A pairing operation is performed by the functional components included in the pairing operation device 10 according to the first embodiment. A result of the pairing operation is written in the memory 12.

(Step S62: Cryptographic Process)

The cryptographic processing unit 31 performs a cryptographic process using the result of the pairing operation obtained in step S61. The cryptographic process includes processes of cryptographic primitives such as an encryption process, a decryption process, a signature process, and a verification process.

The encryption process is the process to transform data in a plaintext state into a ciphertext so as to conceal the data from third parties. The decryption process is the process to transform a ciphertext transformed by the encryption process into data in a plaintext state. The signature process is the process to generate a signature for at least one of detecting the falsification of data and checking the source of data. The verification process is the process to perform at least one of detecting the falsification of data and checking the source of data, using a signature generated in the signature process.

For example, it is conceivable that the cryptographic processing unit 31 uses a result of a pairing operation that takes as input an element of a ciphertext and an element of a decryption key, so as to generates a message obtained by decrypting the ciphertext.

### Effects of Second Embodiment

As described above, the cryptographic processing device 30 according to the second embodiment realizes a cryptographic process, using the functional components of the pairing operation device 10 according to the first embodiment. The pairing operation device 10 according to the first embodiment can efficiently calculate a pairing operation. Therefore, the cryptographic processing device 30 according to the second embodiment can efficiently implement a cryptographic process.

### REFERENCE SIGNS LIST

10: pairing operation device, 10A: Miller function calculation device, 10B: final exponentiation simplification device, 10C: final exponentiation calculation device, 11: processor, 12: memory, 13: storage, 14: communication interface, 15: electronic circuit, 21: Miller function calculation unit, 22: exponentiation simplification unit, 221: decomposition unit, 222: transformation unit, 223: first generation unit, 224: second generation unit, 23: exponentiation calculation unit, 30: cryptographic processing device, 31: cryptographic processing unit.

1. A final exponentiation calculation device comprising:
processing circuitry to:
decompose an exponent part into an easy part indicated in Formula 1 and a hard part indicated in Formula 2, using a cyclotomic polynomial, the exponent part being in a final exponentiation calculation part of a pairing operation on an elliptic curve that is represented by a polynomial r(u), a polynomial q(u), a polynomial t(u), an embedding degree k, and a parameter u, and is a Barreto-Lynn-Scott (BLS) 21 curve with the embedding degree k of 21, and
transform the hard part obtained as a result of decomposition into a linear sum of the polynomial q(u) indicated in Formula 3
$$\begin{matrix}( {q ( u )}^{7} - 1 ) \cdot ( {q ( u )}^{2} + q ( u ) + 1 ) & [ Formula 1 ] \\ \frac{{Φ}_{21} ( q ( u ) )}{r ( u )} & [ Formula 2 ] \\ {\sum }_{i = 0}^{11} {λ}_{i} ( u ) {q ( u )}^{i} & [ Formula 3 ] \\ where & \\ {λ}_{11} ( u ) = {u}^{4} - {u}^{3} - u + 1 , & \\ {λ}_{10} ( u ) = ( u - 1 ) {λ}_{11} ( u ) , & \\ {λ}_{9} ( u ) = u {λ}_{10} ( u ) , & \\ {λ}_{8} ( u ) = u {λ}_{9} ( u ) + {λ}_{11} ( u ) , & \\ {λ}_{7} ( u ) = u {λ}_{8} ( u ) - {λ}_{11} ( u ) , & \\ {λ}_{6} ( u ) = u {λ}_{7} ( u ) , & \\ {λ}_{5} ( u ) = u {λ}_{6} ( u ) + {λ}_{11} ( u ) , & \\ {λ}_{4} ( u ) = u {λ}_{5} ( u ) , & \\ {λ}_{3} ( u ) = u {λ}_{4} ( u ) - {λ}_{11} ( u ) , & \\ {λ}_{2} ( u ) = u {λ}_{3} ( u ) + {λ}_{11} ( u ) , & \\ {λ}_{1} ( u ) = u {λ}_{2} ( u ) , & \\ {λ}_{0} ( u ) = u {λ}_{1} ( u ) - {λ}_{11} ( u ) + 3. & \end{matrix}$$

2. The final exponentiation calculation device according to claim 1,
wherein the parameter u is 2⁴³+2³⁹+2³⁷+2⁶.

3. A pairing operation device comprising
the final exponentiation calculation device according to claim 2,
wherein the processing circuitry calculates a Miller function of the pairing operation by repeating doubling steps four times, performing one addition step, repeating doubling steps twice, performing one addition step, repeating doubling steps 31 times, performing one addition step, and repeating doubling steps six times.

4. The pairing operation device according to claim 3,
wherein the processing circuitry calculates, for a function value, which is a result of calculating the Miller function, an exponentiation of the easy part and an exponentiation of the hard part that has been transformed into the linear sum, so as to calculate a result of the pairing operation.

5. A cryptographic processing device to perform a cryptographic process, using a result of the pairing operation calculated by the pairing operation device according to claim 3.

6. A cryptographic processing device to perform a cryptographic process, using a result of the pairing operation calculated by the paring operation device according to claim 4.

7. A final exponentiation calculation method comprising:
decomposing an exponent part into an easy part indicated in Formula 4 and a hard part indicated in Formula 5, using a cyclotomic polynomial, the exponent part being in a final exponentiation calculation part of a pairing operation on an elliptic curve that is represented by a polynomial r(u), a polynomial q(u), a polynomial t(u), an embedding degree k, and a parameter u, and is a Barreto-Lynn-Scott (BLS) 21 curve with the embedding degree k of 21; and
transforming the hard part into a linear sum of the polynomial q(u) indicated in Formula 6
$$\begin{matrix}( {q ( u )}^{7} - 1 ) \cdot ( {q ( u )}^{2} + q ( u ) + 1 ) & [ Formula 4 ] \\ \frac{{Φ}_{21} ( q ( u ) )}{r ( u )} & [ Formula 5 ] \\ {\sum }_{i = 0}^{11} {λ}_{i} ( u ) {q ( u )}^{i} & [ Formula 6 ] \\ where & \\ {λ}_{11} ( u ) = {u}^{4} - {u}^{3} - u + 1 , & \\ {λ}_{10} ( u ) = ( u - 1 ) {λ}_{11} ( u ) , & \\ {λ}_{9} ( u ) = u {λ}_{10} ( u ) , & \\ {λ}_{8} ( u ) = u {λ}_{9} ( u ) + {λ}_{11} ( u ) , & \\ {λ}_{7} ( u ) = u {λ}_{8} ( u ) - {λ}_{11} ( u ) , & \\ {λ}_{6} ( u ) = u {λ}_{7} ( u ) , & \\ {λ}_{5} ( u ) = u {λ}_{6} ( u ) + {λ}_{11} ( u ) , & \\ {λ}_{4} ( u ) = u {λ}_{5} ( u ) , & \\ {λ}_{3} ( u ) = u {λ}_{4} ( u ) - {λ}_{11} ( u ) , & \\ {λ}_{2} ( u ) = u {λ}_{3} ( u ) + {λ}_{11} ( u ) , & \\ {λ}_{1} ( u ) = u {λ}_{2} ( u ) , & \\ {λ}_{0} ( u ) = u {λ}_{1} ( u ) - {λ}_{11} ( u ) + 3. & \end{matrix}$$

8. A non-transitory computer readable medium storing a final exponentiation calculation program that causes a computer to function as a final exponentiation calculation device to perform:
a decomposition process of decomposing an exponent part into an easy part indicated in Formula 7 and a hard part indicated in Formula 8, using a cyclotomic polynomial, the exponent part being in a final exponentiation calculation part of a pairing operation on an elliptic curve that is represented by a polynomial r(u), a polynomial q(u), a polynomial t(u), an embedding degree k, and a parameter u, and is a Barreto-Lynn-Scott (BLS) 21 curve with the embedding degree k of 21; and
a transformation process of transforming the hard part obtained as a result of decomposition by the decomposition process into a linear sum of the polynomial q(u) indicated in Formula 9
$$\begin{matrix}( {q ( u )}^{7} - 1 ) \cdot ( {q ( u )}^{2} + q ( u ) + 1 ) & [ Formula 7 ] \\ \frac{{Φ}_{21} ( q ( u ) )}{r ( u )} & [ Formula 8 ] \\ {\sum }_{i = 0}^{11} {λ}_{i} ( u ) {q ( u )}^{i} & [ Formula 9 ] \\ where & \\ {λ}_{11} ( u ) = {u}^{4} - {u}^{3} - u + 1 , & \\ {λ}_{10} ( u ) = ( u - 1 ) {λ}_{11} ( u ) , & \\ {λ}_{9} ( u ) = u {λ}_{10} ( u ) , & \\ {λ}_{8} ( u ) = u {λ}_{9} ( u ) + {λ}_{11} ( u ) , & \\ {λ}_{7} ( u ) = u {λ}_{8} ( u ) - {λ}_{11} ( u ) , & \\ {λ}_{6} ( u ) = u {λ}_{7} ( u ) , & \\ {λ}_{5} ( u ) = u {λ}_{6} ( u ) + {λ}_{11} ( u ) , & \\ {λ}_{4} ( u ) = u {λ}_{5} ( u ) , & \\ {λ}_{3} ( u ) = u {λ}_{4} ( u ) - {λ}_{11} ( u ) , & \\ {λ}_{2} ( u ) = u {λ}_{3} ( u ) + {λ}_{11} ( u ) , & \\ {λ}_{1} ( u ) = u {λ}_{2} ( u ) , & \\ {λ}_{0} ( u ) = u {λ}_{1} ( u ) - {λ}_{11} ( u ) + 3. & \end{matrix}$$
